(19) United States
(12) Patent Application Publication
(10) Pub. No.: US 2009/0150236 A1
(43) Pub. Date: Jun. 11, 2009

(54) Digital asset management system and method

(75) Inventor: Vince Price, Beaverton, OR (US)

Correspondence Address: ATER WYNNE LLP, 1331 NW Lovejoy St. Suite 900, PORTLAND, OR, 97209-2785, US

(73) Assignee: Rhapline, Inc.

(21) Appl. No.: 12/001,346

(22) Filed: Dec. 10, 2007

(51) Int. Cl. G06Q 30/00; G06Q 10/00

(52) U.S. Cl. 705/14; 705/1

(57) ABSTRACT

A digital asset management system includes an asset reputation manager (ARM) server for responding to a client request to install client software and to verify user and asset ID, client software to interact with a prospective user of the digital asset and bonus assets that might be available based on asset reputation evaluation by the manager, a use redemption server responsive to the ARM server for supplying authentication and bonus asset options to a trusted user, and a content distribution network server for assisting the use redemption server in obtaining and fulfilling asset offerings and for managing and communicating pools of unissued and issued ARM IDs to the ARM server. An asset's “reputation” is calculated and potentially rewarded with bonus assets and other goods and services based upon a) the number of unique, global users of the asset, b) the number of global uses of the asset, c) the asset's age, and d) the frequency of use of the asset.

### FIELD OF THE INVENTION

The invention relates generally to the field of digital asset distribution, protection, and consumption. More particularly, the invention relates to protection, authentication, valuation and bonus offerings in connection with the marketing and distribution of digital assets as well as related goods and services.

### BACKGROUND OF THE INVENTION

Marketing and distribution of digital assets such as CDs, music downloads, DVDs, etc. heretofore has relied on restrictive measures such as digital rights management (DRM), e.g. encryption/decryption, of such assets with punitive results for consumers or black marketers who violate the copyright rules. Detection of unauthorized possession of protected digital assets is fraught with difficulty and is prohibitively costly. Most asset creators (e.g. musicians), their producers, and social network asset purveyors, have relied on policing associations (e.g. BMI, ASCAP), legislation (e.g. the Digital Millennium Copyright Act (DMCA)), and safe harbors for collecting compulsory royalties, mitigating infringements, and otherwise enforcing their rights in the realms of increasingly one-click and ubiquitous asset distribution. Other asset creators and their producers have relied on lawsuits against accused illegal down-loaders or copiers (sharers) of allegedly pirated assets. All such enforcement heretofore has been compliance-regulatory or punitive, e.g. has used a ‘stick’ model rather than a ‘carrot’ model.

Historically, owners of copyrighted assets have applied a transaction-based purchase-to-use business model to compel users to compensate them or otherwise obtain permission before being granted access to stated asset or realize its full value. Once the purchase or permission granting transaction was complete, the relationship between the copyright holder and user was terminated and the asset's full value is conveyed to the user. Without explicit permission of the copyright holder, the asset is considered to have no value to the user.

Increasingly, digital assets are circulated freely on the Internet and through the sharing of physical media such as flash media or writable discs. Existing restrictive measures such as DRM and encryption permit neither the user nor the copyright holder a viable means to realize partial benefit of such an asset that circulates with our without the permission of the copyright holder. These restrictive measures also produce only a limited means to trace the circulation of these assets and the characteristics of that circulation.

Online and physical distribution of digital assets has created market opportunities for a longer-term, cooperative relationship between the copyright holder and the user wherein the digital asset realizes a new form of value, one which is utilized during the asset's circulation after the initial rights transaction.

### BRIEF DESCRIPTION OF THE DRAWINGS

FIG. 1 is a system block diagram illustrating the asset reputation-based distribution system in accordance with one embodiment of the invention in which an application is known, and trusted by the system.

FIG. 2 is a system block diagram illustrating the asset reputation-based distribution system in accordance with another embodiment of the invention in which an application such as a web browser running a HTML page or client-side scripts is not trusted and must rely on a second, installed application that is trusted by an asset reputation manager (ARM) system to interact with the ARM system.

FIG. 3 is a process flow diagram illustrating the asset reputation-based distribution flow in accordance with one embodiment of the invention by which a user may be permitted to use an asset.

FIG. 4 is a process flow diagram illustrating the asset reputation-based distribution flow in accordance with another embodiment of the invention by which a user may obtain or use a bonus asset relevant to another asset provided by a commerce server and an ARM host server.

FIG. 5 is a process flow diagram illustrating the asset reputation-based distribution flow in accordance with yet another embodiment of the invention by which a user may obtain a “bound” asset from a content distribution network (CDN) server aided by a commerce server, and by which pools of issued and as-yet-unissued asset IDs are maintained by the CDN server and the ARM host server.

FIG. 6 is a process flow diagram illustrating the invented method of calculating an asset's reputation.

### SUMMARY OF THE INVENTION

It is an object of this invention to produce a system that can uniquely identify and passively track usage of a unique digital asset by users on a global basis without the application of restrictive measures such as DRM or necessarily interfering with the usage of that asset by users.

It is a further object of this invention to provide protocols by which any compatible client software program may interact with this system to submit and retrieve attributes related to the usage of a specified unique digital asset using a network connection such as the Internet.

It is a further object of this invention to achieve the foregoing objects means of implementations designed to attain integration with existing environments and programs, particularly on the Internet, while retaining the flexibility to adapt to the continuing evolution of standards for online services.

In one aspect of the invention, software is provided that produces and delivers globally unique asset identifiers on demand to a computer program running on a remote host via a network and stores this globally unique asset identifier in a database or other computer readable storage medium for later retrieval. For the sake of convenience, this software is heretofore referred to as “the asset ID issuer system.”

In a second aspect of the invention, software is provided that collects asset usage event records related to a uniquely identified digital asset from a computer program running on a remote host using a network and stores these asset usage event records in a database or other computer readable storage medium for later retrieval. For the sake of convenience, this software is heretofore referred to as “the asset usage recording system,”

In a third aspect of the invention, software is provided that retrieves collected usage records pertaining to an identified digital asset from its computer readable storage medium. These records are then used to produce attributes relating to the usage of the specified digital asset, said attributes may include: number of unique users which have used the asset, number of global uses observed for the asset, time elapsed since the asset was initially distributed, which will be referred to as asset age, interval between usages of the asset by users and or average of a collection of interval and a calculated value which is a “reputation” value. These usage attributes may be provided to a computer running on a remote host in response to a query by that or a related host. It is appreciated that these attributes may represent global usage pertaining to a digital asset and as such yield greater usefulness than similar attributes collected only by a single host or user's computer.

In a fourth aspect of the invention, a method is provided that calculates a value known as the reputation value, which describes the usage of an identified digital asset in a unique way. This reputation value is calculated by retrieving usage records relating to an identified digital asset from its computer readable storage medium, assimilating those usage records relating and examining attributes of those records, attributes may include: number of users using the asset, number of global uses of the asset, asset age and time interval between asset usages or derivatives of that interval or intervals. It is appreciated that this calculation yields a result that is ultimately more useful than any of the individual attributes utilized to calculate it. The reputation value calculation also provides a third party with a convenient method of evaluating the usage patterns relating to an identified digital asset using a single indicator, thereby eliminating the need to perform detailed analysis of individual usage attributes and saving time and resources for such a third party evaluator. This reputation value may be provided to a computer running on a remote host in response to a query by that or a related host.

In a fifth aspect of the invention, software is provided that enables a computer program running on a remote host to obtain a globally unique asset identifier from the asset ID issuer system using a network and to bind or embed that identifier into a digital asset prior to its distribution to a user. This host is typically one involved in the distribution of digital assets to users such as a content distribution network (CDN). For the sake of convenience, this type of host is referred to herein as a CDN server, or, simply, CDN.

In a sixth aspect of the invention, software is provided that enables a computer program running on a remote host to extract a globally unique identifier from a digital asset and to transfer use/user data (indicating that the specified asset is or has been used by a specified user) to the asset usage recording system using a network.

In a seventh aspect of the invention, software is provided which enables a computer program running on a remote host to retrieve globally collected and aggregated usage attributes and derivative data relating to an identified digital asset from another computer program running on a remote host using a network. These retrieved usage attributes may reflect global usage of the specified asset beyond any which are observable by any single computer program or host. As such, it is appreciated that such retrieved usage attributes are ultimately more useful than those that could be derived without the use of such a global aggregator, also referred to herein as an ARM server.

In an eighth aspect of the invention, software is provided that enables a computer program running on a remote host to report the usage of an identified digital asset to a the asset usage recording system in order to contribute to a global collection of usage records pertaining to the identified digital asset.

### DETAILED DISCLOSURE OF THE INVENTION AND EXEMPLARY USE CASE

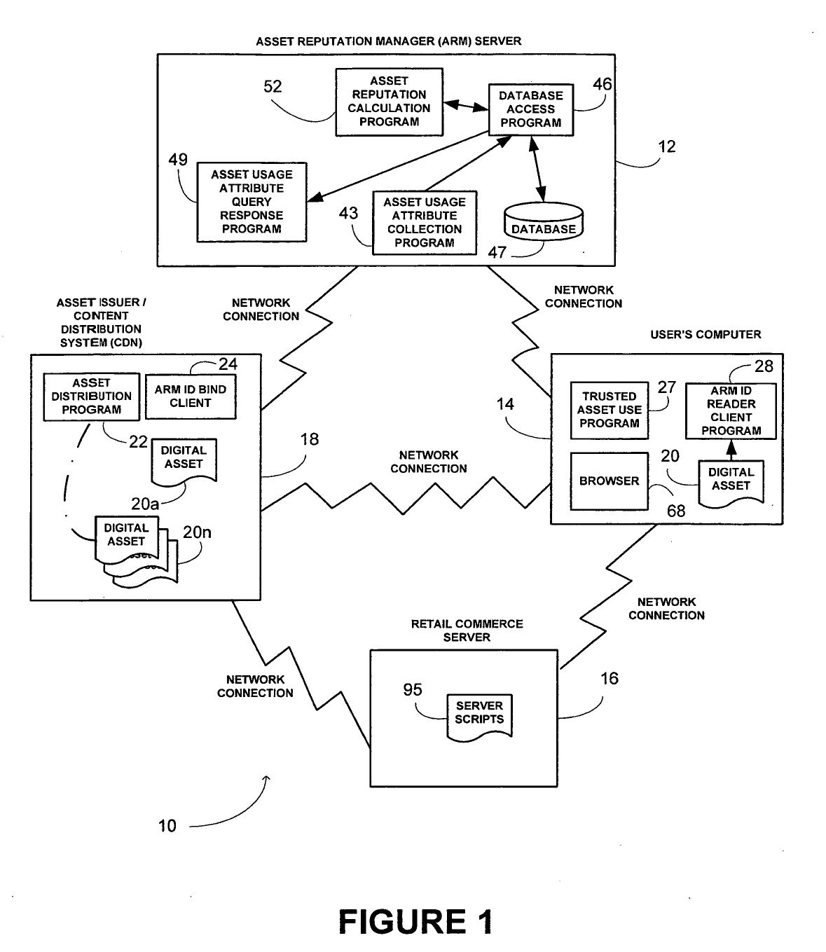

FIG. 1 illustrates one diagrammatic representation of the invented digital asset management system 10. System 10 includes an asset reputation manager (ARM) server 12 network-connected to a user's computer 14. (ARM server 12 is also referred to herein as a digital asset management server.) ARM server 12 and user's computer 14 also are network connected to a retail commerce server 16 and to a content distribution network (CDN) server 18, as illustrated. Those of skill in the art will appreciate that retail commerce server 16 might, for example, be a music retailer like iTunes.com or amazon.com, whereby a user purchases a musical digital asset and the retailer authorizes the CDN to issue the purchased tune, track or album to user's computer 14.

Digital assets 20a, . . . 20n (referred to generally herein as digital asset(s) 20) are so ID-bound by CDN server 18 prior to issuance to user, as will now be described. An asset distribution program 22 has been authorized to one or more distribute digital assets 20 to users so long as they are bound by an ARM ID bind client program 24 executed in CDN server 18. Such ID bound client program issues each digital asset 20 to a user with the unique asset ID. Those of skill in the art will appreciate that CDN server 18 similarly can distribute so-called bonus, e.g. discounted or free, digital assets similarly ID bound to users who own digital assets of high reputation. Such acts as a reward or incentive system more akin to a ‘carrot’ (luring) approach, directly contradicting conventional wisdom that says digital rights enforcement must be by use of a ‘stick’ (beating) approach.

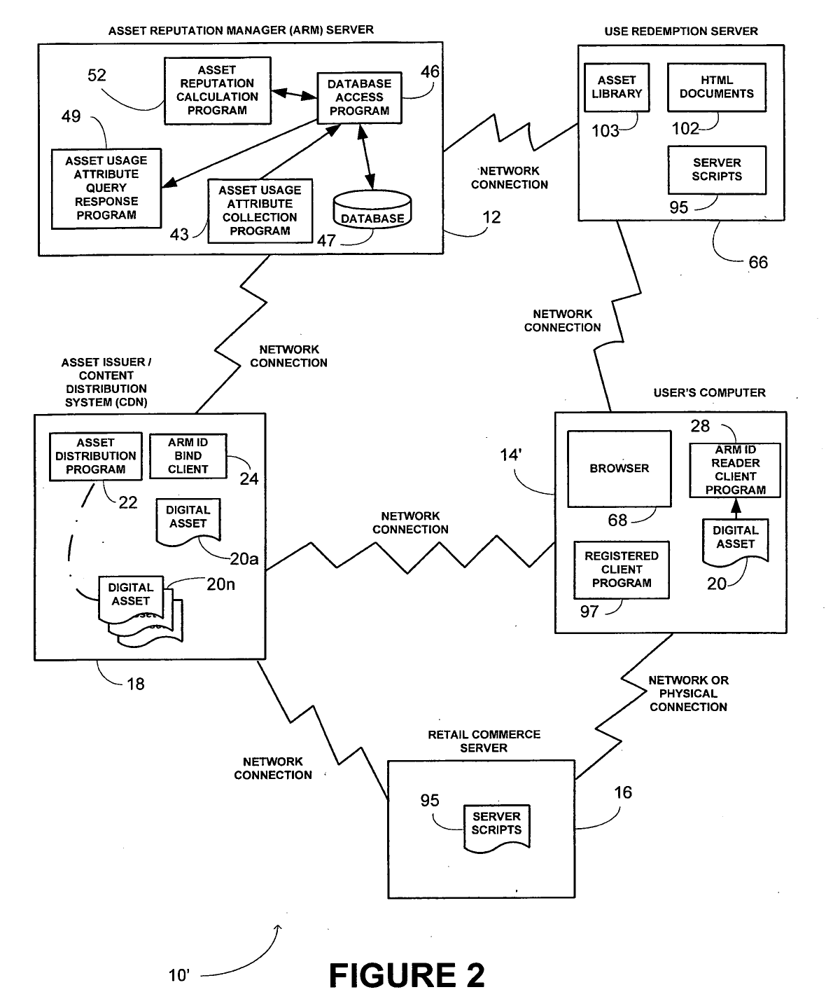

Referring still to FIG. 1, ARM server 12 collects records pertaining to the usage of a digital asset, responds to client requests for asset usage attributes, and issues globally unique asset identifiers. CDN server 18 or its functional equivalent obtains a unique identifier from ARM server 12 and binds that identifier to a digital asset. It will be appreciated that digital asset management system 10 may include user's computer 14 or similar device that reports the usage of a digital asset to ARM server 12 and optionally retrieves attributes or a reputation value pertaining to a specified digital asset from the ARM server. Referring briefly to FIG. 2, digital asset management system 10 also may include a third-party (3P) commerce system 26 or similar server for acting as a trusted proxy between a user of a digital asset and the ARM server.

The issuance of a globally unique identifier to every digital asset and subsequent collection and global aggregation of usage data which associates uses with a uniquely identified asset user pertaining to that digital asset enables the observation of that asset's usage or circulation characteristics on a global scale. In accordance with the invented system 10, individual users of assets voluntarily contribute data pertaining to their use of a specific digital asset to a server or group of servers that aggregate all contributed data globally.

A digital asset may be in the form of a digital computer file, data stream, picture image or any other sort of asset which may be stored and or transmitted using a digital network. Those of skill will appreciate that digital assets 20 can be shared among two or more users via, for example, hard-copy loans or sales, as well as peer-to-peer (P2P) or other network connections.

Referring to FIG. 1, asset issuer/content distribution system 18, herein referred to as a CDN, may be seen to contain a number of server type computers, which may be personal computers, workstations, or other similar computing hardware utilizing an operating system or similar program. It will be appreciated that any hardware and software platform suitably may be used.

The inventive novelty is that this computer or set of computers executes programs that implement the functionality of an ARM ID bind client program 24, a program authorized to associate ARM asset identifiers with digital assets. ARM ID bind client program 24 may execute on a single computer or a number of computers of CDN 18 and may reveal its functionality to a single computer or a number of computers of a CDN 18 using a network. ARM ID bind client program 24 has the ability to connect to ARM server 12 using a network. ARM ID bind client program 24, upon its initial installation into a computer of CDN 18, may immediately register itself with ARM server 12 to establish its identity. ARM server 12 subsequently provides the ID bind client program with a unique registration identifier, which ARM ID bind client program 24 permanently retains, as will be described.

All users or user's computers 14 of the system are uniquely identified using globally unique user identifiers issued exclusively by ARM system 12 at some time prior to their use by asset reputation management system 10.

The term “use”, as it pertains to an ID-bound asset, refers to a process or program on a user's computer (or another program on yet another computer acting on behalf of a program of a user's computer) by which ARM server 12 is informed of a “usage event” involving the digital asset. This may or may not be concurrent with that or another computer program requesting usage attributes for that or another ID-bound asset.

When an ID-bound digital asset is used or otherwise consumed by a user, a notification of that usage event is sent to ARM server 12, which collects such event notifications to contribute to a global usage statistic or measure formed by ARM server 12. The usage event notification is generally delivered to ARM server 12 by a user's computer 14 via a network, although alternative means could be used within the spirit and scope of the invention. The usage event notification may be delivered by any authorized asset use program executing on any remote host or other computer program. Said usage event notifications may include the globally unique asset identifier, the globally unique user identifier, and/or other relevant attributes.

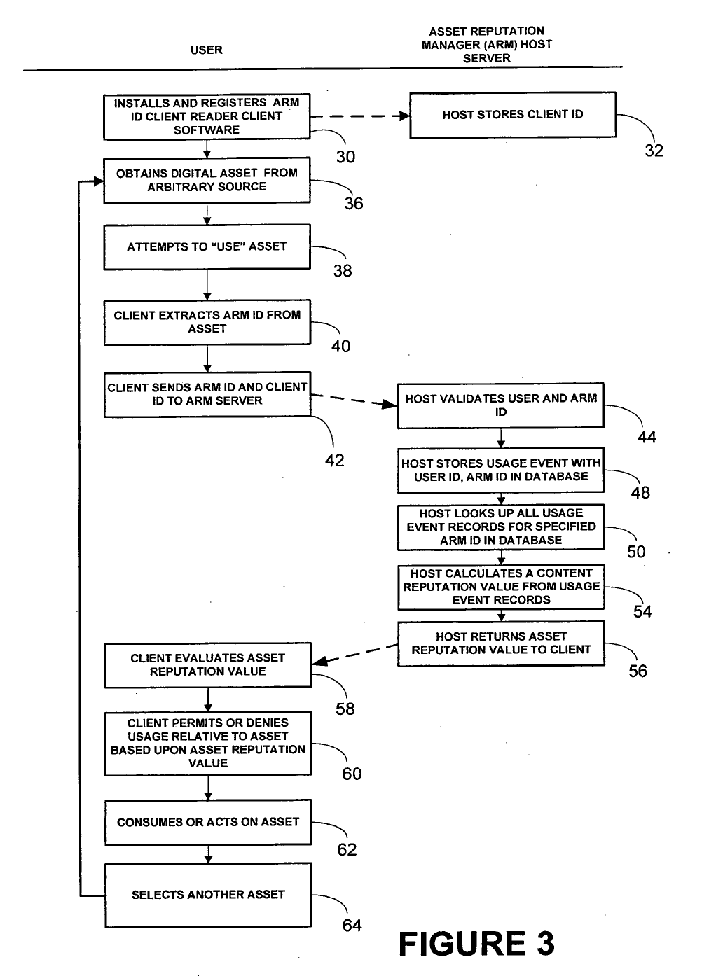

Referring collectively now to FIGS. 1 and 3, a “trusted” asset use program 27 illustrates the “use” of an ID-bound digital asset on user's computer 14. The user's asset use application is trusted in that it is relied upon to manage the extraction of the globally unique asset identifier from an asset being used and also to obtain an accurate globally unique user ID pertaining to the user desiring to use the asset. Trusted use asset use program 27 may independently obtain and evaluate that asset's usage attributes such as user count, reputation value, or others, if desired, and may make decisions based on that evaluation.

The user first installs ARM ID reader client program 28, which registers itself at step 30 with ARM server 12. The ARM server 12 generates a globally unique identifier, which subsequently becomes the “user identifier”, which ARM server 12 stores at step 32 in its computer readable storage medium such as a database 47, and returns this identifier back to ARM ID reader client program 28, which also retains that identifier as its user identifier. This installation process generally occurs only once during the lifetime of ARM ID reader client program 28. Next, user's computer 14 obtains at step 36 an ID-bound digital asset 20 from CDN server 18 (and/or from a P2P network or elsewhere). The user attempts to “use” asset 20 at step 38, at which point ARM ID reader client program 28 extracts the globally unique asset identifier from the asset at step 40 and sends that asset identifier and the previously retained user identifier to the ARM server 12 at step 42. This serves as an effective usage event notification to ARM server 12.

An asset usage attribute collection program 43 of ARM server 12 receives the usage event notification, and then at step 44 it validates the asset identifier and the user identifier to determine if both identifiers are ones previously issued and activated by ARM server 12. Such validation is performed via a database access program 46. If both identifiers are valid, then ARM server 12 stores this usage event in its computer accessible storage medium or database 47 at step 48. An asset usage attribute query/response program 49 of ARM server 12 then looks up all usage records at step 50 pertaining to the ID-bound asset for which usage event was submitted. An asset reputation calculation program 52 of ARM server 12 processes all or part of the asset usage records previously looked up to calculate an asset reputation value and other pertinent usage data values at step 54, which are then sent back to the user's computer 14 at step 56.

Trusted asset user program 27 of the user's computer 14 then evaluates the returned asset reputation value and/or other usage attributes pertaining to the asset 20 in question at step 58 and subsequently permits or denies the action requested by the user at step 60, which in turn acts on or consumes the asset 20 or other related assets 20, or not, at step 62. At step 64, another asset 20 may be selected by the user.

Referring to FIG. 1, usage data returned to user's computer by asset usage query/response program 49 may contain the number of users using the asset, the number of global uses of the asset by all users, the asset's age, the frequency of uses for the asset, as well as one or more averages or other derivatives thereof, or any other relevant attributes including a calculated reputation value.

An asset's “reputation” is calculated by ARM server 12's asset reputation calculation program 52 and potentially a user is rewarded with bonus assets and/or other goods and/or services.

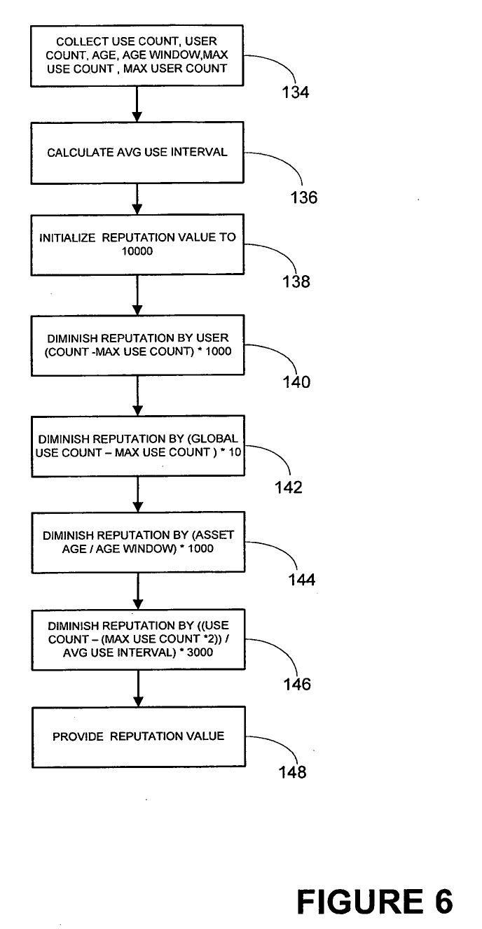

The asset reputation calculation takes into account such variables as a) the number of unique, global users of the asset, b) the number of global uses of the asset, c) the asset's age, and d) the frequency of use of the asset. Those of skill in the art will appreciate that more or fewer parameters or attributes of the digital asset may be factored into the asset reputation calculation. The method by which the calculation is performed in accordance with one embodiment of the invention will be described below by reference to FIG. 6. It will be appreciated that an asset's reputation is used in accordance with the invention to reward or restrict a user's access to the asset or to related free or discounted (“bonus”) assets or related commercial offerings.

If the user has shared his or her digital asset with a P2P peer, e.g. via a P2P network connection or by actually lending the physical asset to the peer, then its reputation value is diminished. This diminution of reputation by sharing is detected when the asset copy is plugged into, or otherwise play is attempted, on a different computer by the user's peer or other user (identified by their ARM account ID).

FIG. 2 diagrammatically illustrates yet another embodiment of the invented system 10′. System 10′ includes an asset reputation manager (ARM) server 12 network-connected to a (bonus) use redemption server 66, to a user's computer 14′, and possibly also to an asset issuer/content distribution system (CDN) 18. Those of skill in the art will appreciate that use redemption server 66 might, for example, be a service/system provider like rhapLine, Inc., the assignee of the present invention. Such a use redemption server interacts with ARM server 12 to evaluate a digital asset's reputation value and to determine whether to fulfill the reward/bonus/discount associated with “use” of the digital asset. (User's computer 14 may also be connected to one or more P2P networks, local area networks, or other environments in which digital assets may be shared between users.) In these aforementioned respects, system 10′ generally is identical to system 10.

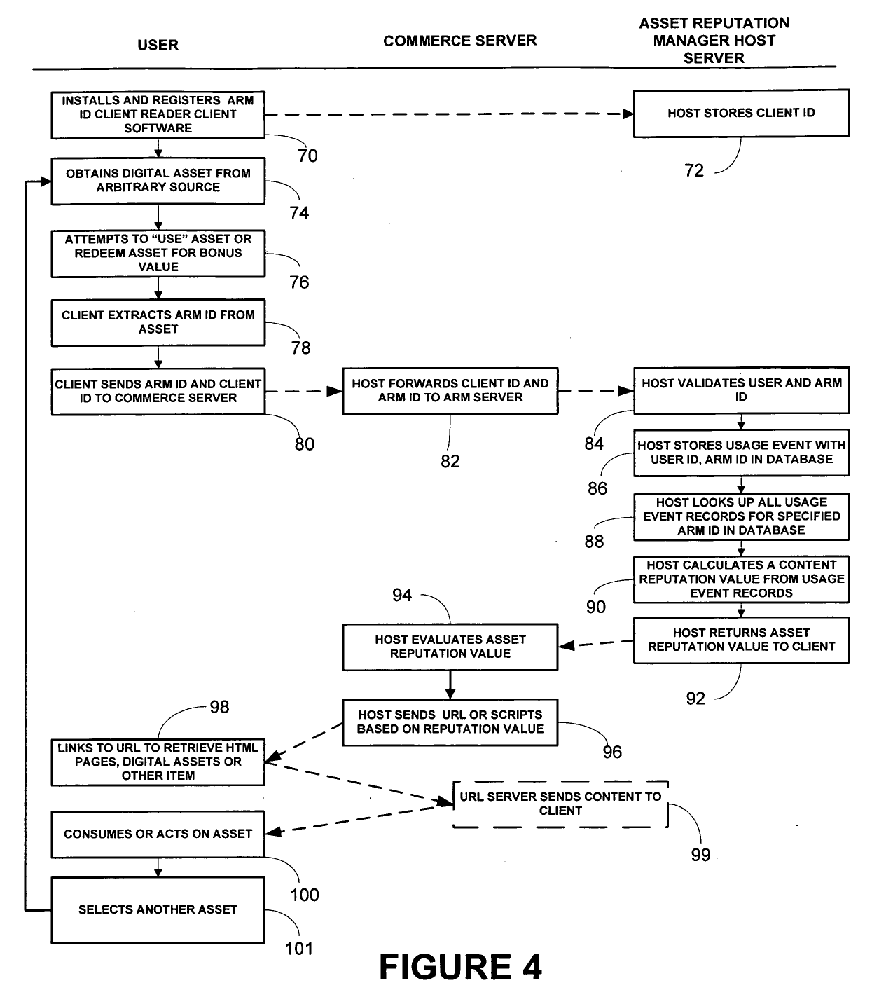

Referring collectively now to FIGS. 2 and 4, an “un-trusted” asset use application such as a browser 68 within user's computer 14′ represents a method of obtaining and using an ID-bound digital asset on a user's computer 14′. The user's asset use application is not trusted in the following respect: it is relied upon to manage the extraction of the globally unique asset identifier from an asset being used but not necessarily to obtain an accurate globally unique user ID pertaining to the user desiring to use the asset. This un-trusted use application also is not authorized to evaluate an ID-bound asset's usage attributes or reputation value or other attributes to make decisions based upon that evaluation. Instead, this application relies upon a third-party commerce server 66 to provide an ARM user identifier and to interact directly with ARM server 12 and to evaluate returned asset usage attributes and/or reputation value pertaining to an asset 20.

The user first installs the ARM ID reader client program 28 on their computer 14′, which registers itself at step 70 with ARM server 12. ARM server 12 generates a globally unique identifier, which subsequently becomes the “user identifier”, which the ARM server stores at step 72 in its computer readable storage medium such as database 47, and returns this identifier back to ARM ID reader client program 28, which also retains that identifier as its user identifier. This installation process generally occurs only once during the lifetime of the ARM ID reader client program 28. Next, the user's computer at step 74 obtains an ID-BOUND digital asset 20 from a CDN server or a P2P network or any other source. The user attempts to “use” the asset at step 76, at which point ARM ID reader client program 28 extracts the globally unique asset identifier from the asset at step 78 and sends that asset identifier and the previously retained user identifier to use redemption server 66 at step 80 (which 3) commerce server 66 may or may not modify the user identifier to match any user membership identifier based on its own settings). Use redemption server 66 then forwards the use notice to the ARM server 12 at step 82. This serves as an effective usage event notification to the ARM server 12.

Asset usage attribute collection program 43 of ARM server 12 receives the usage event notification, and then it validates the asset identifier and the user identifier at step 84 to determine if both identifiers are ones previously issued and activated by ARM server 12. If both identifiers are valid, ARM server 12 stores this usage event in its computer accessible storage medium or database 47 at step 86. Asset attribute query/response program 49 of ARM server 12 then looks up all usage records at step 88 pertaining to the ID-bound asset for which usage event was submitted. Asset reputation calculation program 52 of ARM server 12 processes all or part of the asset usage records previously looked up to calculate an asset reputation value and other pertinent usage data values at step 90, which are then sent back to the use redemption server 66 at step 92.

Use redemption server 66 subsequently evaluates the asset usage attributes, reputation value or other values at step 94 and generates scripts 95 or instructions based upon that usage attribute or reputation evaluation. Such scripts or instructions (which may also reside in Retail commerce server 16, as illustrated in FIGS. 1 and 2) may include a URL to an asset, bonus content, reward, exclusive web page or any sort of instruction, data or asset. Use redemption server 66 sends these instructions to the user's computer 14′ at step 96, and a registered client program 97 therein makes use the received instructions, scripts, URL or data directly, e.g. to consume the asset. Alternatively, it makes use of the received instructions, etc. to make a second link to an online entity at step 98 to obtain some form of online content made accessible by using those instructions, data or URL at step 99. In this way, the use redemption server may make certain content, data or other assets available or unavailable to the user's computer based upon the evaluation of the obtained asset usage attributes or reputation. User's computer 14′ consumes or otherwise acts on retrieved asset 20 at step 100, and optionally selects another asset at step 101. As shown in FIG. 2, use redemption server 66 also may include an asset library 102 and/or HTML documents 103.

Referring to FIG. 2, usage data returned to use redemption server 66 by the asset usage attribute query/response program 49 of ARM server 12 may contain the number of users using the asset, the number of global uses of the asset by all users, the asset's age, the frequency of uses for the asset, derivative values such as one or more averages based thereon, or any other relevant and desired attributes including a calculated reputation value.

An asset's “reputation” is calculated by the ARM server 12's asset reputation calculation program 52 and the asset or user thereof is potentially rewarded with bonus assets and/or other goods and/or services.

The asset reputation calculation takes into account such variables as a) the age of the asset, b) the number of unique users of the asset, c) the number of global uses of the asset, and d) the frequency of use of the asset. Those of skill in the art will appreciate that more or fewer parameters or attributes of the digital asset may be factored into the asset reputation calculation. The method by which the calculation is performed in accordance with one embodiment of the invention will be described below by reference to FIG. 6. It will be appreciated that an asset's reputation is used in accordance with the invention to reward or restrict a user's access to the asset or to related free or discounted (“bonus”) assets or related commercial offerings.

If the user has shared his digital asset with his P2P peer, e.g. via a network connection or by actually lending the physical asset to the peer, then its reputation value is diminished. This diminution of reputation by sharing is detected when the asset copy is plugged into or otherwise play is attempted on a different computer by the user's peer or by another user (identified by their ARM account ID).

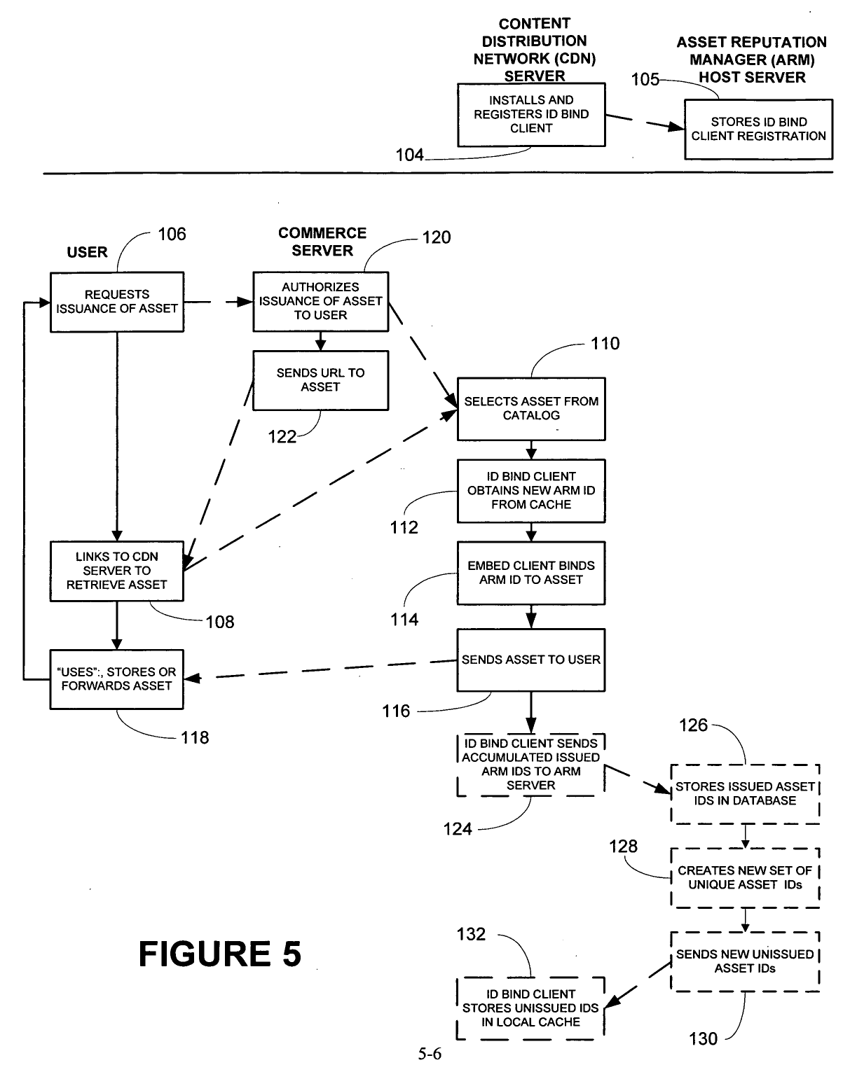

FIG. 5 illustrates the flow of process of distributing and ID-binding a digital asset. Any person or entity with a computer connected to CDN or a network may obtain a digital asset which is an ID-bound asset. No special software or computer hardware is required.

The process of distributing and ID-binding an asset is now understood from FIGS. 1, 3 and 5. First, at step 104, CDN 18 installs and registers ARM ID bind client. Next, ARM server 12 stores the ARM ID bind client registration at 105. When a user desires to obtain a digital asset from a CDN 18 or other distribution entity directly, a program executing on the user's computer 14, such as browser 68, will generally make the request at step 106 for the asset by linking at step 108 to CDN 18 using a network. Those of skill in the art will appreciate that this program may be a browser 68 or it may be any program capable of linking to CDN 18 using a network, e.g. it may be registered client program 97. CDN 18, upon receiving the request for an asset from a user's computer 14′, selects the desired asset from its catalog at step 110.

CDN 18 next obtains a globally unique asset identifier at step 112 using ARM ID bind client program 24 from ARM server 12 (or from a local cache, e.g. a local disc, the purpose of which is to reduce data traffic between the ARM ID bind client of the CDN and the ARM itself) of previously obtained globally unique asset identifiers. This identifier is then associated with digital asset 20 at step 114 by modifying an existing computer file, stream or digital representation of that asset to include the unique identifier such that the resulting digital representation will always include the identifier unless deliberate measures are taken by the user to remove that identifier. Next, CDN 18 at step 116 sends that asset to the user's computer 14′ using the network in which the request was received. At this point, the asset may be used by the user at step 118.

It is common but not mandatory for a third party entity, e.g. online retailer or commerce server 16, to be used to authorize the distribution of a specified asset before the CDN 18 will send the asset to the user. In this case, the CDN access program 68 of the user's computer 14′ does not connect directly to CDN 18 as a first step. Instead, user' computer 14′ requests an asset first from retail commerce server 16 at step 106, then retail commerce server 16 (or registered client program 97) authorizes the issuance of the asset to the CDN at step 120. After authorization, retail commerce server 16 sends the URL at step 122 for retrieving the asset from CDN 18 to user's computer 14′, which in turn links to CDN 18 using this URL at step 108. Such authorization may specify a content identifier, which, not to be confused with an asset identifier, instead indicates generally the name of the asset, e.g. file name, track name, etc., such that that a copy of the asset can be retrieved from the CDN's library prior to distribution of that copy. Such authorization may also include attributes such as the desired maximum number of users authorized to use that asset, the desired maximum number of global uses authorized for that asset, the desired maximum lifetime for that asset, and so on. These attributes may be utilized by the ARM server's asset reputation calculation program 52 in the course of calculating a reputation value for that asset.

The asset identifier of an ID-bound digital asset should survive subsequent redistributions of the asset when such distribution does not involve a deliberate modification or perturbation of that digital representation of that asset. In other words, the file is not modified or converted by the user. Normal distribution methods such as file transfer via portable recordable media (flash drive) or network file transfer to another computer via an email attachment, file copy or Hyper Text Transfer Protocol (HTTP) upload/download should not interfere with the asset's unique identifier.

Following the initial distribution of a digital asset by CDN 18 or similar server to a user's computer 14′ or intermediary, ARM ID bind client program 24 notifies ARM server 12 that the specified globally unique asset identifier has been issued and is subsequently activated by the system at step 124. ARM ID bind client program 24 may accumulate a number of issued asset identifiers for a time to send them all out at once if desired. Said notification may consist of the asset identifier itself and other data. Upon receiving notification of a number of issued asset identifiers from ARM ID bind client program 24, ARM server 12 records this activation notification in its database or computer readable storage medium 47 at step 126, preparing ARM server 12 to receive subsequent asset usage data contributed by users of that asset. This notification may take place immediately or may be delayed for an arbitrary length of time. After storing the notification, ARM server 12 may respond to ARM ID bind client program 24 by generating a number of new globally unique asset identifiers at step 128 and sending them back to the ARM ID bind client program at step 130, which stores them in a local cache, e.g. a local disc or suitable alternative (for convenience, network traffic reduction and latency avoidance), at step 132.

Following the initial distribution of a digital asset by a CDN or similar server to a user or intermediary, that asset may be used or redistributed to other users.

A digital asset may be obtained by an arbitrary user using arbitrary methods including the initial distribution by a CDN. As long as a digital asset carries the globally unique identifier issued by the ARM server, that asset is considered to be an ID-bound asset.

FIG. 6 illustrates the process of calculating an asset reputation for an ID-bound asset. MAXIMUM_USER_COUNT is set to an initial value. MAXIMUM_USES is set to an initial value. AGE_WINDOW is set to an initial value. From the database of the ARM server, asset usage records are retrieved for a specified asset identifier at step 134. The average interval between uses is calculated at step 136. Reputation value is initialized to 10000 at step 138. Reputation value is diminished by (MAXIMUM USER COUNT minus the number of users who have used the asset) times 1000 at step 140. Reputation value is diminished by (asset global use count minus MAXIMUM_USES) times (*) 10 at step 142. Reputation value is diminished by (asset age divided by (/) AGE_WINDOW) times 1000 at step 144. Reputation value is diminished by ((asset global use count minus (MAXIMUM_USES times 2)) divided by average interval between uses) times 3000 at step 146. Reputation value at step 148 is supplied to an evaluator for bonus, discounting and/or other reward to the digital asset user. Those of skill in the art will appreciate that, if any diminution quantity is less than or equal to (≦) zero, then it is not further diminished.

Thus, variable multiples of numbers representing attributes are subtracted from a high-value baseline, i.e. the attributes are combined in a weighted average, in accordance with one embodiment of the invention in arriving at a calculated digital asset reputation value. Those of skill in the art nonetheless will appreciate that suitable alternative ways of representing reputation value baselines, choosing and evaluating one or more attributes relevant to a digital assets reputation value, discounting such reputation value by calculation based upon the attributes, and arriving thereby at an asset reputation value or the like are contemplated as being within the spirit and scope of the invention.

It is understood that the mathematical details of the asset reputation calculation could be altered to improve the results of the calculation. Accordingly, alternative calculations are contemplated as being within the spirit and scope of the invention.

Exemplary Use Case

Those of skill in the art will appreciate that the simplest use scenario might be as follows:

a) a user plays or otherwise uses content on his or her computer, the content typically having come from the CDN;

b) the user receives a determined reputation value from the ARM server;

c) if the reputation value is adequate (e.g. above a defined threshold), then the user obtains a bonus such as bonus content, the bonus content typically having come from a use redemption server;

d) the user shares the asset with other users, such sharing typically being via a network; and, as a result,

e) the reputation value of the shared asset is diminished.

This simple use case may be repeated over and over. But at some point, the reputation value will have been diminished so much that its value is inadequate to support further bonuses, and perhaps so diminished as to support no further use of the digital asset by the originally authorized user thereof.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A digital asset management system comprising:
a client computer operated by a user possessing a purchased or downloaded or other means digital asset including a unique user identifier, and
a digital asset management server coupled with the client computer, the management server responsive to a query from the client computer evaluating the digital asset based upon the asset identifier to determine usage attributes relevant to that asset.

2. The system of claim 1, wherein the asset usage attributes are in the form of an asset reputation value based upon predetermined reputation calculation criteria.

3. The system of claim 1 further comprising:
a use redemption server coupled with the management server, the use redemption server selectively enabling the user in a high-reputation-value case to obtain further digital assets on a discounted or free basis.

4. The system of claim 1, wherein the asset usage attributes include the number of unique users who have used specified asset.

5. The system of claim 1, wherein the asset usage attributes include the number of times specified asset has been used globally.

6. The system of claim 1, wherein the asset usage attributes include the interval between usages of the asset by one or more users.

7. The system of claim 1 further comprising:
a mechanism for affixing the unique user asset identifier to the purchased or downloaded digital asset before such a purchase or download by the user.

8. The system of claim 1 further comprising:
a mechanism coupled with the management server for maintaining a pool of unique asset IDs for assignment to unique assets and for reporting the status of the pool to the management server.

9. The system of claim 1 further comprising:
a mechanism for informing the management server of the usage of a digital asset prior to, during, or after the usage by the user.

10. The system of claim 1, wherein the asset usage attributes are in the form of an asset reputation value based upon predetermined reputation calculation criteria, the system further comprising
a mechanism for affixing the unique user asset identifier to the purchased or downloaded digital asset before such a purchase or download by the user; and
a use redemption server coupled with the management server, the use redemption server selectively enabling the user in a high-reputation-value-case to obtain further digital assets on a discounted or free basis.

11. The system of claim 10 further comprising:
a mechanism coupled with the management server for maintaining a pool of unique asset IDs for assignment to unique assets and for reporting the status of the pool to the management server.

12. The system of claim 11 further comprising
a mechanism for informing the management server of the usage of a digital asset prior to, during, or after the usage by the user.

13. A digital asset distribution method comprising:
playing or otherwise using original digital asset content on a user computer;
calculating a reputation value for the original digital asset by a remote server and transmitting the same to the user computer;
receiving at the user computer the calculated reputation value transmitted by the remote server; and
determining whether the calculated reputation value meets predefined high-value criteria, and if so then making available to the user computer bonus digital asset content related to the original digital asset content.

14. The method of claim 13, wherein, if the original digital asset content has been shared by the user computer with another user computer, then the remote server diminishes the calculated reputation value before the transmitting of the same to the user computer.

15. A digital asset reputation calculation mechanism comprising:
a unique digital asset characterized by one or more unique attributes including an age of the asset, a number of unique users of the asset, a number of global uses of the asset, and a frequency of use of the asset;
a set of one or more general digital asset usage parameters, the set including one or more chosen from the group including an age of the asset, a number of unique users of the asset, a number of global uses of the asset, and a frequency or interval of use of the asset;
a digital asset standard reputation number stored in a memory, the reputation number representing a combination of the general asset usage parameters;
a calculator coupled with the unique usage attributes, the calculator configured to calculate therefrom a number representative of a combination of such usage attributes, the calculator further comparing the representative number with the standard reputation number to assign a reputation score pertaining to the digital asset.

16. The mechanism of claim 15, wherein the combination represents a weighted average of the usage attributes.

17. The mechanism of claim 15, wherein the calculator is configured to subtract from an initial high value variable multiples of the usage attributes until such initial high value is diminished to zero.

18. A digital asset management system comprising:
a client computer operated by a user possessing a purchased or downloaded or other means digital asset including a unique user identifier, and
a digital asset management server coupled with the client computer, the management server responsive to an event notification from the client computer regarding the usage of specified digital asset,
a computer accessible storage which collects asset usage event data.

19. The system of claim 12, wherein the client computer sends asset usage event notifications to the server computer via a network.

20. The system of claim 17, wherein the asset usage event notification includes the identifier of the asset.

21. The system of claim 17, wherein the asset usage event notification includes the identifier of the asset user.

22. The system of claim 17, wherein the asset usage event notification includes the time or date of asset usage.

23. The system of claim 12, wherein the computer accessible storage is a database.

24. The system of claim 12, wherein the system collects asset usage counts.

25. The system of claim 12, wherein the system collects the identity of all users who use a specified asset.

26. The system of claim 12, wherein the system collects the time and date of asset usage.
